(19) United States
(12) Patent Application Publication
(10) Pub. No.: US 2016/0193902 A1
(43) Pub. Date: Jul. 7, 2016

(54) SUN VISOR WITH SWITCHABLE COVER OVERLYING VANITY MIRROR

(71) Applicant: FORD GLOBAL TECHNOLOGIES, LLC, Dearborn, MI (US)

(72) Inventors: Anna Miller Hill, Belleville, MI (US); Neal Randolph Osstyn, Royal Oak, MI (US); Peter David Alexander Jones, Birmingham, MI (US); Charles Alan Rocco, Milford, MI (US)

(21) Appl. No.: 14/589,220

(22) Filed: Jan. 5, 2015

(51) Int. Cl. B60J 3/02; B60J 3/04; B60Q 3/02

(52) U.S. Cl. CPC B60J 3/0282; B60Q 3/0226; B60J 3/02; B60J 3/04; B60Q 2500/00

(57) ABSTRACT

A sun visor for a vehicle includes a visor body, a minor carried on the visor body and a cover overlying the minor. A control module controls operation of the cover and switches the cover between an opaque state wherein the mirror is hidden from view and a transparent state wherein the mirror is visible to view and available for use.

### TECHNICAL FIELD

This document relates generally to the motor vehicle equipment field and, more particularly, to a sun visor incorporating a switchable cover overlying a vanity mirror.

### BACKGROUND

In the United States and many other countries there is a requirement that the reflective surface of the vanity mirror not be visible on the driver's visor during vehicle operation. Avoiding reflective surfaces on the sun visor is an important consideration for preventing unwanted glare. The standard solutions are to eliminate a vanity mirror from the driver's side sun visor or provide a vanity mirror cover.

Vanity minor covers are generally of two types. The first type is a sliding cover. The second is a hinged cover. Either type has onerous packaging requirements. More specifically, sliding covers require that a sun visor has an internal space for the cover to slide into that is as wide as the mirror. Often times this limits the size of the vanity mirror that may be provided. Hinged covers require the visor to be made relatively thick so that the cover is flush with the visor when closed. Either solution requires the sun visor to incorporate additional bulk and weight thereby necessitating a stronger damping spring to hold the visor in the storage position against the headliner and to resist the tendency for the sun visor to vibrate or flutter. Thus, traditional vanity minor covers substantially increase sun visor assembly time and production costs.

In contrast, the sun visor disclosed herein incorporates a stationary cover that overlies the vanity mirror and is switchable from an opaque state whereby the vanity mirror is hidden to a transparent state whereby the vanity minor is visible for use. Further the sun visor incorporates a control module for controlling the operation of the cover. The control module includes a controller and a component selected from a group consisting of a timer, a position sensor, a voice command component and combinations thereof that provide a number of unique and beneficial functions.

### SUMMARY

In accordance with the purposes and benefits described herein, a sun visor is provided for a motor vehicle. That sun visor comprises a visor body, a minor carried on the visor body and a cover overlying the mirror. Further, the sun visor incorporates a control module for controlling operation of the cover. The control module includes a controller and a component selected from a group consisting of a timer, a position sensor, a voice command component and combinations thereof. The controller operates in response to input from the timer, the position sensor and/or the voice command component to switch the cover between an opaque state whereby the vanity minor is hidden from view and a transparent state whereby the vanity mirror is visible for viewing and use.

In one possible embodiment, the control module of the sun visor specifically includes a timer. The controller is responsive to the timer to return the cover to the opaque state from the transparent state after a predetermined period of time.

In one possible embodiment, the control module of the sun visor specifically includes a position sensor. The controller is responsive to the position sensor to switch the cover from the transparent state to the opaque state when the sun visor is displaced into a storage position wherein the sun visor is held adjacent the headliner of the motor vehicle or a secondary use position wherein the sun visor is positioned to block a portion of the side window of the motor vehicle.

In yet another possible embodiment, the control module of the sun visor includes a voice command component. In this embodiment the cover may be switched between the transparent and opaque states on the voice command of the vehicle operator.

In any of the possible embodiments, the sun visor may further include at least one light source carried on the visor body. In one possible embodiment, that light source is positioned under the cover with the minor.

In one possible embodiment, the visor body further includes an actuator switch for the cover. That switch may be provided on the visor body adjacent the cover. In another possible embodiment the visor body is devoid of any actuator switch for the cover and operation of the cover is exclusively provided through voice command.

In accordance with an additional aspect, a method of operating a sun visor mirror in a vehicle is provided. That method comprises the steps of covering a minor on the sun visor with a cover that is switchable between an opaque state and a transparent state and switching the cover between states by means of a controller responsive to voice commands whereby the reflective surface of the minor may be hidden from view or exposed for use.

In one possible embodiment, the method further includes switching, by the controller, the cover to the opaque state whenever the sun visor is positioned in a storage position adjacent a headliner of the vehicle. Further the method may include switching, by the controller the cover to the opaque state when the sun visor is positioned over of a portion of a side window of a vehicle.

In addition, in one possible embodiment the method further includes switching, by the controller, from the transparent state to the opaque state after a predetermined period of time.

In the following description, there is shown and described several preferred embodiments of the sun visor. As it should be realized, the sun visor is capable of other, different embodiments and its several details are capable of modification in various, obvious aspects all without departing from the sun visor as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the sun visor and together with the description serve to explain certain principles thereof. In the drawing figures:

FIG. 1 is a front elevational of the sun visor illustrating the cover in the transparent state so that the underlying mirror and optional light source are visible.

FIG. 2 is a view similar to FIG. 1 but illustrating the cover in the opaque state whereby the underlying mirror and optional light source are hidden from view.

FIG. 3 is a block diagram of the control module for operating the cover.

FIG. 4 is a block diagram of the controller of the control module.

FIG. 5a is a schematic view of the sun visor in the storage position adjacent the headliner of the vehicle.

FIG. 5b is a schematic view of the sun visor in the second use position overlying a portion of the vehicle side window.

Reference will now be made in detail to the present preferred embodiments of the sun visor, examples of which are illustrated in the accompanying drawing figures.

### DETAILED DESCRIPTION

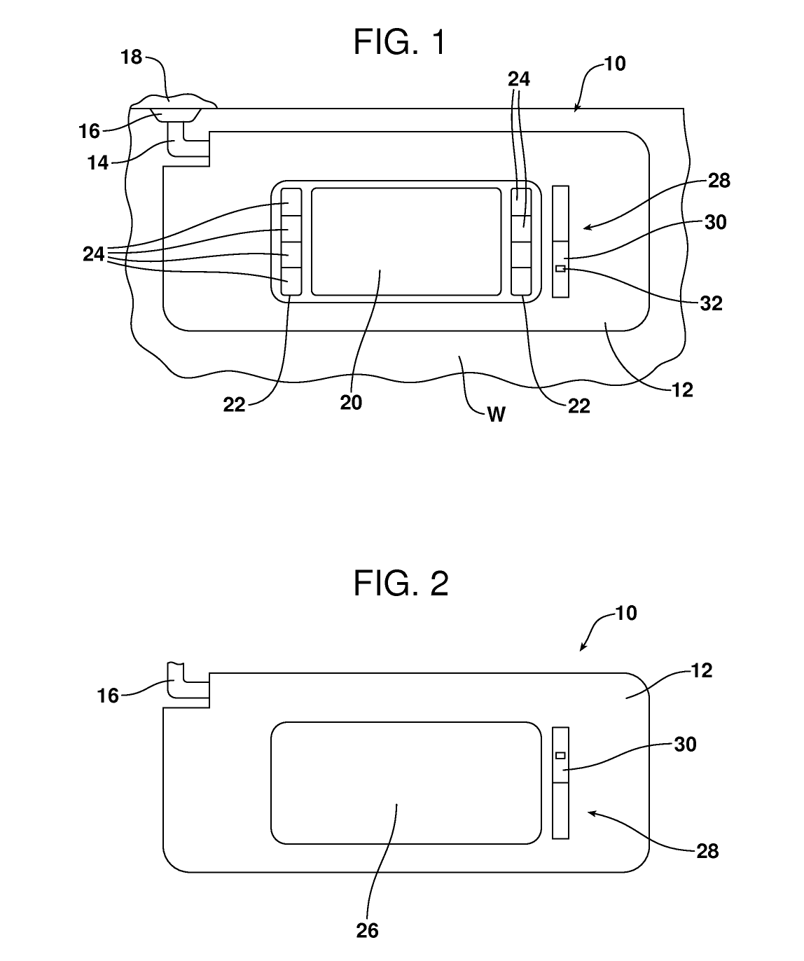

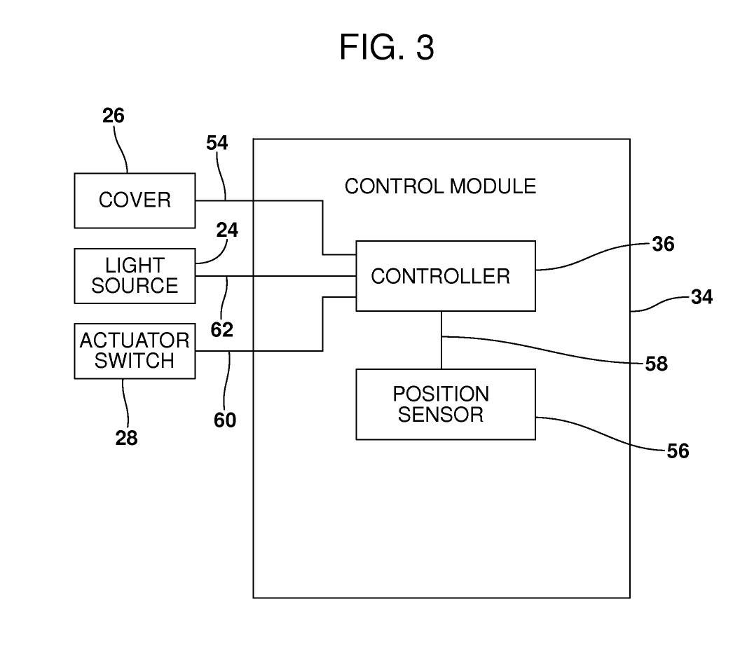

Reference is now made to FIGS. 1 and 2 illustrating the sun visor 10. The sun visor 10 includes a visor body 12 that is pivotally mounted on the support rod 14. Support rod 14 is pivotally mounted in the bracket 16 whereby the sun visor 10 is secured to the body or roof through the headliner 18. In FIG. 1, the sun visor 10 is illustrated in a first, deployed position wherein the sun visor has been rotated downwardly to cover an upper portion of the windshield W. A vanity minor 20 is carried on the sun visor body 12. The vanity mirror 20 may be secured or captured in a cavity of the visor body 12, mounted to a substrate of the visor body 12 by means of an adhesive or connected in accordance with some other means as known in the art.

In the illustrated embodiment, two optional light assemblies 22 are provided: one on each side of the vanity minor 20. Each of the illustrated light assemblies 22 comprises four light sources 24 which may, for example, take the form of light emitting diodes. A cover 26 overlies the vanity mirror 20 and the light assemblies 22. As will be described in greater detail below, the cover 26 is switchable between the transparent state illustrated in FIG. 1 wherein the vanity mirror 20 and light assemblies 22 are visible through the cover and an opaque state, illustrated in FIG. 2, wherein the vanity mirror 20 and light assemblies 22 are hidden from view by the cover 26. An actuator switch 28 may also be carried on the visor body 12. In the illustrated embodiment the actuator switch 28 comprises a slide actuator 30 including a projecting control lug 32 which may be engaged with the fingers to shift the slide actuator 30 between the on position illustrated in FIG. 1 and the off position illustrated in FIG. 2.

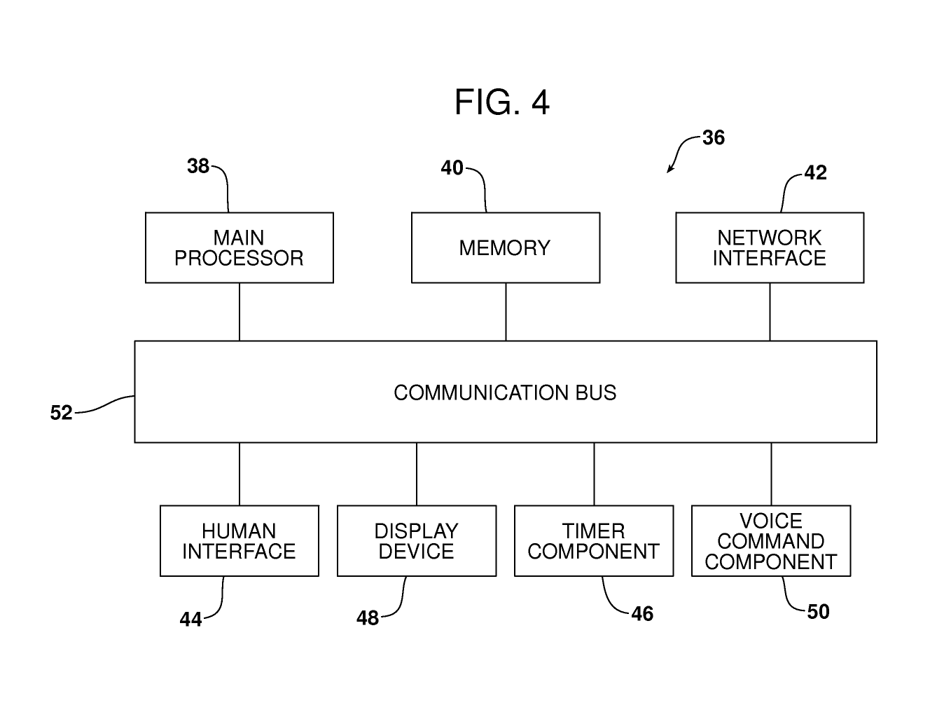

As illustrated in FIG. 3, the sun visor 10 further includes a control module 34. The control module 34 includes a controller 36, in the form of a dedicated microprocessor or electronic control unit (ECU).

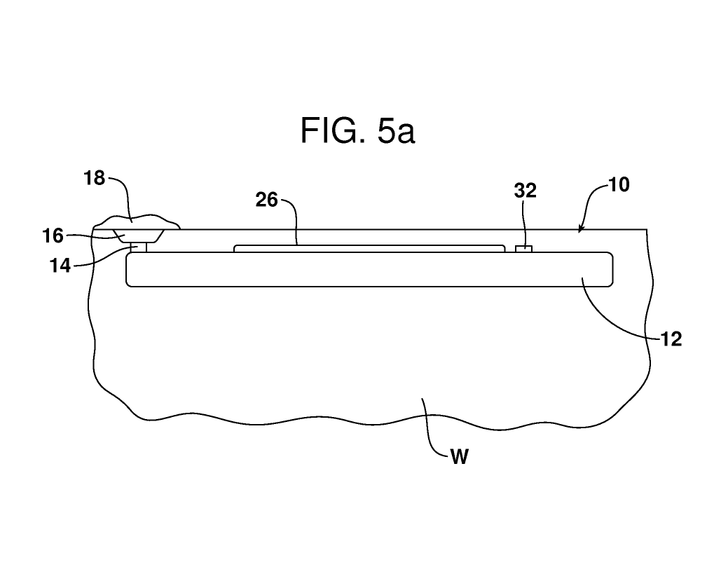

As illustrated in FIG. 4, such a controller 36 may comprise a computing device having one or more processors 38, one or more memories 40, one or more network interfaces 42, a human interface 44, a timer component 46, a display device, such as a multifunction display with touchscreen capability 48 and a voice command component or speech processor 50 that all communicate with each other over a communication bus 52. In one possible embodiment the controller 36 is a body control module (BCM) which performs a number of interior body electrically based functions including, for example, interior locking, remote key entry, interior lighting, exterior lighting, windshield wiper control and the like. In some embodiments the BCM 36 may also function to control entertainment functions (e.g. radio, CD player and communications such as telephone and Internet communications over a wireless network). In some embodiments the body control module 36 is connected by a communication bus (not shown) to other control modules that provide one or more of these additional functions.

As should be appreciated, where a timer component 46 is provided, the controller 36 may be responsive to that component to switch the switchable cover 26 from the transparent state illustrated in FIG. 1 to the opaque state illustrated in FIG. 2 after a certain, predetermined period of time such as, for example, 60 seconds.

Where the controller 36 includes a voice command component/speech processor 50, the controller may be responsive to the voice command component/speech processor to switch between the transparent state and opaque state illustrated in FIGS. 1 and 2. For example, the vehicle driver may issue the voice command, “minor on” and the controller then directs a control signal through a signal line 54 to the cover 26 whereby an appropriate electrical charge is sent to the cover to cause the cover to switch from the opaque state illustrated in FIG. 2 to the transparent state illustrated in FIG. 1. After using the vanity minor 20, the driver may issue the voice command “minor off” causing the controller 36 to issue a second signal along the signal line 54 to the cover 26 producing the necessary electrical charge to cause the cover to change from the transparent state illustrated in FIG. 1 to the opaque state illustrated in FIG. 2 whereby the vanity mirror 20 and light assemblies 22 are hidden from view.

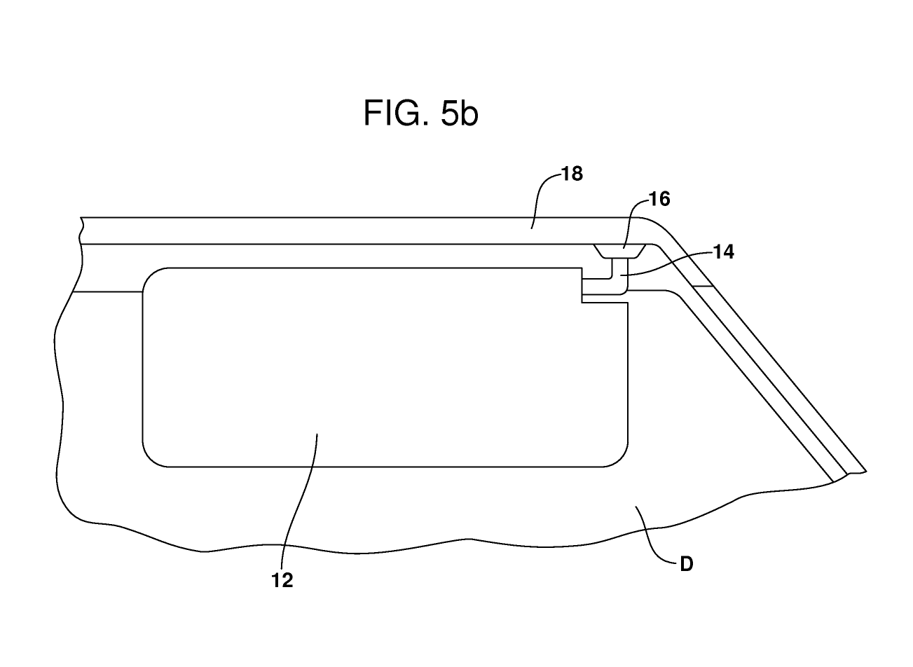

As further illustrated in FIG. 3, the control module 34 may also include a sun visor position sensor 56. The position sensor 56 monitors the position on the visor body 12. Thus, for example, when the visor body 12 is displaced into the storage position wherein it is pivoted on the support rod 14 to rest along the roof 18 adjacent the headliner, (see FIG. 5a), the position sensor 56 sends a signal along signal line 58 to the controller 36. The controller 36 responds to that signal by sending a control signal to the cover 26 switching the cover 26 to the opaque state if the cover was in the transparent state when it was displaced into the storage position.

Similarly, if the position sensor 56 detects the visor body 12 being positioned in the second use or deployed position (see FIG. 5b) whereby the visor body covers a portion of the side window D of the vehicle, a signal is sent from the position sensor through the signal line 58 to the controller 36. In response to that signal, the controller 36 sends a signal along signal line 54 to the cover 26 causing the cover to switch from the transparent state to the opaque state if the cover was in the transparent state when it was displaced into the second use or deployed position illustrated in FIG. 5b.

As should be appreciated, the actuator switch 28 is optional and need not be provided if the cover 26 is to be controlled exclusively via voice command.

In one possible embodiment the actuator switch 28 only controls the light assemblies 22 and not the operation of the cover. As illustrated in FIG. 3, the actuator switch 28 may be connected by signal line 60 to the controller 36 which is responsive thereto to control the function of the light sources 24. The controller 36 will then send a signal along line 62 to switch those light sources 24 off any time the cover 26 is in the opaque state.

In any of the embodiments, the cover 26 may comprise a switchable glass such as a polymer dispersed liquid crystal (PDLC) or an electrochromic (EC) glass. Such electro-optical glass technologies alternate from opaque to transparent. The electro-optical glass requires an electrical current to change states, but can maintain either transparent or opaque state without power. Thus, the switchable cover 26 overlying the vanity mirror 20 and light assemblies 22 will not drain the battery if left in either state when the vehicle is turned off.

In summary, the sun visor 10 described herein provides a number of benefits and advantages. First and foremost it allows the elimination of hinged and sliding vanity mirror covers thereby reducing sun visor weight. Further, it eliminates failure modes associated with the excessive application of opening force being applied to the vanity cover causing potential deformation or breakage. Elimination of a sliding or hinged cover also allows for an improved appearance as well as a thinner sun visor. Voice command function even allows the elimination of any cover or light source actuator switch 28 on the visor body 12 thereby further improving the “clean” appearance of the sun visor. In addition, the switchable cover 26 and voice command function add a “wow factor” to the product that has not been available in the past.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A sun visor for a vehicle, comprising:
a visor body;
a mirror carried on said visor body;
a cover overlying said mirror, said cover being switchable between an opaque state and a transparent state; and
a control module for controlling operation of said cover, said control module including a controller and a component selected from a group consisting of a timer, a position sensor, a voice command component and combinations thereof, wherein said control module being responsive to input from the component to switch said cover between an opaque state and a transparent state.

2. (canceled)

3. The sun visor of claim 1, further including at least one light source carried on said visor body.

4. The sun visor of claim 3, wherein said at least one light source is positioned under said cover with said mirror.

5. The sun visor of claim 1, wherein said control module includes a position sensor.

6. The sun visor of claim 5, further including at least one light source carried on said visor body.

7. The sun visor of claim 6, wherein said at least one light source is positioned under said cover with said mirror.

8. The sun visor of claim 1, wherein said control module includes a voice command component.

9. The sun visor of claim 8, further including at least one light source carried on said visor body.

10. The sun visor of claim 9, wherein said at least one light source is positioned under said cover with said mirror.

11. The sun visor of claim 10, wherein said visor body is devoid of any actuator switch for said cover.

12. The sun visor of claim 1, further including an actuator switch for said cover on said visor body.

13. The sun visor of claim 1, further including at least one light source and an actuator switch for said at least one light source carried on said visor body.

14. A method of operating a sun visor mirror in a vehicle, comprising:
covering a mirror on the sun visor with a cover that is switchable between an opaque state and a transparent state; and
switching said cover between states by means of a controller responsive to voice commands whereby said mirror may be hidden from view or exposed for use.

15. The method of claim 14, further including switching, by said controller, said cover to said opaque state whenever the sun visor is positioned in a storage position adjacent a headliner of the vehicle.

16. The method of claim 14, further including switching, by said controller, said cover to said opaque state whenever the sun visor is positioned over a portion of a side window of the vehicle.

17. The method of claim 14, further including switching, by said controller, from said transparent state to said opaque state after a predetermined period of time.

18. A sun visor for a vehicle, comprising:
a visor body;
a mirror carried on said visor body;
a cover overlying said mirror, said cover being switchable between an opaque state and a transparent state; and
a control module for controlling operation of said cover, said control module including a controller and a timer, said controller being responsive to said timer to return said cover to said opaque state from said transparent state after a predetermined period of time.
